(19) United States
(12) Patent Application Publication
(10) Pub. No.: US 2026/0226202 A1
(43) Pub. Date: Aug. 6, 2026

(54) PROCESS

(71) Applicant: INEOS EUROPE AG, Vaud (CH)

(72) Inventors: Fabien BINI, Martigues (FR); Atanas TOMOV, Croydon (GB); George Johan Peter BRITOVSEK, London (GB)

(21) Appl. No.: 19/141,465

(22) PCT Filed: Dec. 12, 2023
(86) PCT No.: PCT/EP2023/085398

§ 371 Date: Jun. 20, 2025

(30) Foreign Application Priority Data
Dec. 20, 2022 (EP) 22215172.2

(51) Int. Cl. C08F 4/656; B01J 31/16

(52) U.S. Cl. CPC C08F 4/656; B01J 31/1616; B01J 2231/12; B01J 2531/005; B01J 2531/0208; B01J 2531/22; B01J 2531/46

(57) ABSTRACT

A process for preparing a catalyst, and in particular for preparing a catalyst suitable for polymerisation of olefins. In particular, there is provided a process for preparing an alpha-olefin polymerisation catalyst composition, the process comprising
(1) reacting a silica support with a dialkylmagnesium compound of the formula RMgR1, where R and R1 are the same or different C₂-C₁₂ alkyl groups, in order to form a silica supported organomagnesium composition,
(2) reacting at least one magnesium halide with at least one organic oxygen-comprising compound of titanium to form a Mg-Ti liquid complex, and contacting the silica supported organomagnesium composition with the formed Mg-Ti liquid complex, and
(3) reacting the modified supported organomagnesium composition of step (2) with a titanium halide.

### FIELD AND BACKGROUND OF THE INVENTION

The present invention relates to a process for preparing a catalyst, and in particular for preparing a catalyst suitable for polymerisation of olefins.

Catalysts for polymerisation of olefins, such as ethylene and propylene are well-known in the art. One particular class of catalysts is Ziegler-Natta catalysts. The present invention relates to supported Ziegler-Natta catalysts, which are useful in olefin polymerisation, and more particularly useful in the gas phase and slurry polymerisation of alpha-olefins.

Ziegler-Natta type catalysts are well known and have been used since the early 1950's. Generally, the catalyst comprises a transition metal compound, commonly titanium, and a magnesium compound. The catalysts may be prepared on a support, such as silica. This may have been pre-treated with an organosilicon compound.

WO 99/05187, for example, describes a process for the preparation of a catalyst precursor which comprises the steps of:
(1) reacting a silica carrier material, having from 0.3 to 1.2 mmoles of OH groups per gram of silica, with a dialkylmagnesium compound of the formula RMgR1, where R and R1 are the same or different C2-C12 alkyl groups, in an amount comprised between 0.5 to 1.5 mmoles of dialkylmagnesium per gram of silica, in order to form a silica supported organomagnesium composition,
(2) reacting said silica supported organomagnesium composition with a tetraalkyl orthosilicate, in which the alkyl group contains from 2 to 6 carbon atoms, in an amount comprised between 0.2 to 0.8 mmoles of tetraalkyl orthosilicate per gram of silica,
(3) contacting the product from step (2) with a titanium compound in an amount comprised between 0.3 to 1.5 mmoles per gram of silica, said preparation process being characterised in that it further comprises the additional step of contacting either the product from step (1), or the product from step (2), or directly the silica support with a chlorinated compound (X) having the formula RnSiCl4−n, wherein each R is the same or different and is hydrogen or an alkyl group and n is an integer from 0 to 3, in an amount comprised between 0.2 to 4 mmoles of X per gram of silica.

EP 0522651A2 describes a process for preparing a solid component of catalyst for the (co)polymerization of ethylene by initially contacting a silica support with a solution of magnesium dialkyl or magnesium alkyl chloride, and subsequently impregnating the silica with a solution of magnesium chloride, titanium tetrachloride and titanium tetra-alkoxide, operating with equimolecular or almost equimolecular quantities of titanium tetrachloride and titanium tetra-alkoxide, and with a molar ratio between the magnesium chloride and the titanium compounds of 1 to 10.

### SUMMARY OF THE INVENTION

The present invention provides a process for making an improved catalyst, the catalyst so produced, and a process for the polymerisation of olefin polymers, preferably polymers of ethylene, using said catalyst.

The catalyst, when used for polymerisation of ethylene is very active catalyst and produces polyethylene with a narrow particle size distribution.

Thus, in a first aspect there is provided a process for preparing an alpha-olefin polymerisation catalyst composition, the process comprising
(1) reacting a silica support with a dialkylmagnesium compound of the formula RMgR1, where R and R1 are the same or different C2-C12 alkyl groups, in order to form a silica supported organomagnesium composition,
(2) reacting at least one magnesium halide with at least one organic oxygen-comprising compound of titanium to form a Mg-Ti liquid complex, and contacting the silica supported organomagnesium composition with the formed Mg-Ti liquid complex, and
(3) reacting the modified supported organomagnesium composition of step (2) with a titanium halide.

The process of the present invention is similar in some regards to that of WO 99/05187. However, in the process of the present invention both titanium and magnesium are added in two separate steps and using two different compounds for each of the individual metals.

More specifically, in the process of the present invention magnesium is added via both the dialkylmagnesium compound of the formula RMgR1 and in a separate step via the Mg-Ti liquid complex, whilst titanium is added via both the Mg-Ti liquid complex and via a separate step of the addition of titanium halide.

(It is noted that it is known, for example, to add a titanium halide in several steps rather than all at once. However, in the present invention titanium is added using two different compounds, as is the magnesium.)

It is also the case that the process of the present invention requires three separate steps for the addition of the Mg and Ti compounds. Thus, in the first step a silica support is reacted with a dialkylmagnesium compound to form a silica supported organomagnesium composition. This is therefore a first magnesium addition step. The second step requires contacting of the silica supported organomagnesium composition (i.e. the product of the first step) with a Mg-Ti liquid complex. This is therefore both a second magnesium addition step and a first titanium addition step. In the third step, the modified supported organomagnesium composition of the second step is reacted with a titanium halide. This is therefore a second titanium addition step.

The use of the separate steps and the Mg-Ti liquid complex can provide a catalyst which, when used for polymerisation of ethylene, is very active catalyst and produces polyethylene with a narrow particle size distribution.

### DETAILED DESCRIPTION OF THE INVENTION

More specifically, in the first step the process of the present invention comprises reacting a silica support with a dialkylmagnesium compound of the formula RMgR1, where R and R1 are the same or different C₂-C₁₂ alkyl groups, in order to form a silica supported organomagnesium composition

The silica support may be any suitable silica, and as used herein we may use the terms “silica” and “silica support” interchangeably. The silica support is preferably spherical and/or spheroidal. For the purpose of the present invention and appended claims, spheroidal morphology means shaped like a sphere but not perfectly round, especially an ellipsoid shape that is generated by revolving one or more ellipse around one of its axes. Thus, for the purpose of the present invention and appended claims, by “spherical and/or spheroidal morphology” it is meant that the silica support exhibits spherical and/or spheroidal shape morphology. Such spherical and/or spheroidal morphology of said silica support is usually identified by taking microscopy pictures of said support; this is currently how the man skilled in the art can identify the presence of a spherical and/or spheroidal particles.

The silica support typically comprises more than 98% by weight of silicon dioxide, preferably more than 99% by weight of silicon dioxide.

The silica support should preferably have a median particle size of from 0.1 to 250 μm, preferably from 5 to 200 μm, such as 10 to 150 μm and most preferably from 15 to 100 μm. The International Standard ISO 13320:2009 (“Particle size analysis—Laser diffraction methods”) can be used for measuring the median particle size characteristic. Suitable instruments for the measurement include Malvern Instruments' laser diffraction systems e.g. a Malvern Mastersizer S or a Malvern Mastersizer 2000.

The silica support should preferably have a surface area greater than about 100 m²/g, preferably greater than about 200 m²/g, most preferably from 250 m²/g to 500 m²/g. The silica support may preferably be porous and may have a pore volume from about 0.3 to 5.0 ml/g, typically from 0.5 to 3.0 ml/g. Surface area and pore volume may be determined according to BET volumetric method in British Standard BS 4359/1 (1984 ).

The silica support typically comprises residual surface hydroxyls. Preferably, the silica exhibits a residual surface hydroxyl content comprised between 0.6 and 2 mmole/g of silica, preferably between 1 and 1.6 mmole/g of silica. If required, the level of surface hydroxyl (OH) groups of the silica support can be reduced by heat and/or chemical treatment prior to reaction with the dialkylmagnesium compound.

In one embodiment the silica support may be dried prior to reaction with the dialkylmagnesium compound. For example, the silica may be heated at a temperature of at least 150° C. for up to 24 hours, typically at a temperature from 200° C. to 400° C. (more preferably from 200° C. to 350° C. for about 2 to 20, preferably 4 to 10 hours. The resulting support will be free of adsorbed water and will preferably have a surface hydroxyl content from about 0.6 to 2 mmole/g of silica, more preferably from 1 to 1.6 mmole/g of silica.

A number of methods are known for determining the amount of the hydroxyl groups in silica; for example by using the method disclosed by J. B. Peri and A. L.

Hensley, Jr., in J. Phys. Chem., 1968, 72(8 ), pp 2926-2933, or any of the methods disclosed in “The surface chemistry of amorphous silica/Zhuravlev model (Colloids and Surfaces, A: Physiochemical and Engineering Aspects 173 (2000 ) pages 1-38). For the purpose of the present invention the amount of hydroxyl groups in silica may be measured according to the method described in WO 99/05187.

The silica support may be a commercially available silica. For example, one suitable commercially available silica is marketed under the trademark of ES-70W by Ecovyst. ES-70W silica is a microspheroidal support exhibiting a D50 between 35 and 47 microns (with D10 of 10.0 microns min and D90 of 85.0 microns max), a Pore Volume (IPA) comprised between 1.55 and 1.75 ml/g, and a Surface Area (5 point BET) comprised between 260 and 330 m²/g. Another silica suitable for use in the present invention is a commercially available silica marketed under the trademark of SYLOPOL® 2408D by Grace. This is a white powder consisting of synthetic, amorphous silica, exhibiting the following specifications: a nitrogen pore volume higherthan 1.35 cc/g; a surface area comprised between 280 and 355 m²/g (with D10 of 10.0 microns min and D90 of 85.0 microns max). Another suitable silica is ES757, also marketed by Ecovyst. This has a D50 between 22 and 28 microns, a surface area between 260 and 330m²/g, and a pore volume between 1.55 and 2.00 mL/g The silica support may be prepared by spray drying of washed and aged hydrogel particles or spray setting of a hydrosol. Such processes are well known in the art and typically result in spherical and/or spheroidal particles. The particle size may be adjusted by selection of conditions. The resulting spherical and/or spheroidal particles may be further classified e.g. by sieving to tailor the median particle diameter and reduce the amounts of fine and/or coarse particles. Although handling of the particles may lead to some degree of breakage, particles are preferably not subjected to any deliberate comminution processes. Preferably, the spherical and/or spheroidal particles are prepared by spray setting of a hydrosol, preferably a silica hydrosol. The resulting spherical and or spheroidal hydrogel particles are suitably subjected to washing and aging processes prior to water removal to generate suitable surface area and pore volume.

The dialkylmagnesium compound according to the present invention has the empirical formula RMgR1 where R and R1 are the same or different C2-C12 alkyl groups. Preferably, R and R1 are C2-C10 alkyl groups, such as C4-C10 alkyl groups, more preferably C2-C8 alkyl groups, such as C4-C8 alkyl groups. Butylethylmagnesium, butyloctylmagnesium and dibutylmagnesium are preferably used according to the present invention, dibutylmagnesium being the most preferred. The dibutylmagnesium may, for example, be n-butyl-s-butyl-magnesium.

The contact of the silica and the dialkylmagnesium may be by any suitable method. In a preferred method, the silica support material is slurried in a non-polar solvent and the resulting slurry is contacted with the dialkylmagnesium, typically at a temperature in the range of about 25° to about 100° C., preferably to about 40° to about 60° C. The slurry of the silica carrier material in the solvent may be prepared by introducing the carrier into the solvent, preferably while stirring, and heating the mixture to about 25° to about 100° C., preferably to about 40° to about 60° C., and then contacted with the dialkylmagnesium while the heating is continued at the aforementioned temperature.

Suitable non-polar solvents are materials in which all of the reactants used herein, e.g. the dialkylmagnesium, the titanium compound, are at least partially soluble and which are liquid at reaction temperatures. Preferred non-polar solvents are alkanes, such as isopentane, hexane, n-heptane, octane, nonane, and decane, although a variety of other materials including cycloalkanes, such as cyclohexane, aromatics, such as benzene and ethylbenzene, may also be employed. The most preferred non-polar solvent is hexane.

Prior to use, the non-polar solvent should be purified, such as by percolation through silica gel and/or molecular sieves, to remove traces of water, oxygen, CO2, polar compounds, and other materials capable of adversely affecting catalyst activity.

In the most preferred embodiment there is added only such an amount of the dialkylmagnesium compound that will be deposited-physically or chemically-onto the silica support since any excess may react with other synthesis chemicals in later steps and precipitate outside of the support. The exact molar ratio may be determined on a case-by-case basis e.g. by adding the dialkylmagnesium compound to a slurry of the silica carrier in the solvent, while stirring the slurry, until the dialkylmagnesium compound is detected as a solution in the solvent.

It is also possible to add such an amount of the dialkylmagnesium compound which is in excess of that which will be deposited onto the support, and then remove, e.g. by filtration and washing, any excess of the dialkylmagnesium compound. However, this alternative is less desirable.

Typically, the amount of dialkylmagnesium compound reacted with the silica support is comprised between 0.5 to 5 mmoles per gram of silica, more preferably between 2 to 4 mmoles per gram of silica. (i.e. equivalent to an amount of between 0.5 to 5 mmoles Mg per gram of silica, more preferably between 2 to 4 mmoles Mg per gram of silica.)

In preferred embodiments, the process comprises a step of reacting the silica supported organomagnesium composition with a silicon containing compound, and in particular of the formula Si(OR)_{y}(X)_{z}, where X is a halogen, R is C2-C6 alkyl, and y+z=4. Preferably X is Cl. Suitable silicon containing compounds include SiX₄, and preferably SiCl₄, Si(OR)₂(X)₂ and Si(OR)₄. Preferred compounds of the formula Si(OR)₂(X)₂ are also chlorides i.e. of the formula, Si(OR)₂(Cl)₂. Typical examples are dimethoxydichlorosilane, diethoxydichlorosilane, diisopropoxydichlorosilane, dipropoxydichlorosilane, dibutoxydichlorosilane. Diethoxydichlorosilane is most preferred.

Preferred compounds of the formula Si(OR)₄ which can be used include tetramethoxysilane, tetraethoxysilane, tetraisopropoxysilane, tetrapropoxy silane, tetrabutoxysilane. Tetraethoxysilane is most preferred.

In such embodiments, the process may comprise maintaining the slurry of the silica supported organomagnesium composition obtained by reacting the silica support and the dialkylmagnesium at a temperature comprised between 25° C. and 100° C., preferably between 40° C. and 60° C., for introduction of the silicon containing compound.

Typically, the amount of silicon containing compound added to the silica support is comprised between 0.5 to 5 mmoles per gram of silica, more preferably between 2 to 4 mmoles per gram of silica.

Preferably, the amount of silicon containing compound added is such that a molar ratio of silicon containing compound added to dialkylmagnesium compound added in the preceding step is about 0.2 to about 1.6, more preferably about 0.3 to about 1.5, most preferably about 0.8 to about 1.2.

In step (2) of the present invention the process comprises reacting at least one magnesium halide with at least one organic oxygen-comprising compound of titanium to form a Mg-Ti liquid complex, and contacting the silica supported organomagnesium composition with the formed Mg-Ti liquid complex. It will be apparent that where the silica supported organomagnesium composition has been reacted with a silicon containing compound as described above, then this step will involve the silica supported organomagnesium composition after it has been reacted with said compound.

The magnesium halide may be any suitable magnesium halide. Preferably it is magnesium chloride.

In relation to the organic oxygen-comprising compound of titanium, the term “organic oxygen-comprising compound” is understood to denote any compound in which an organic radical is bonded to the titanium via oxygen, which is to say any compound comprising at least one sequence of titanium-oxygen-organic radical bonds per titanium atom. The organic radicals bonded to the titanium via oxygen are generally chosen from radicals comprising up to 20 carbon atoms and more particularly from those comprising up to 10 carbon atoms. Good results are obtained when these radicals comprise from 2 to 6 carbon atoms. These radicals can be saturated or unsaturated, with a branched chain or with a straight or cyclic chain. They are preferably chosen from hydrocarbon-comprising radicals and in particular from alkyl (linear or branched), alkenyl, aryl, cycloalkyl, arylalkyl and acyl radicals and their substituted derivatives.

Use is preferably made of tetravalent titanium compounds, because they are generally liquid and, in any case, generally soluble.

The organic oxygen-comprising compounds of titanium can be represented by the general formula TiOₓ(OR′)ₘ₋₂ₓ, in which m is the valency of the titanium, R′ represents an organic radical as defined above and x is a number such that 0<x<(m−1)/2. Use is preferably made of compounds in which x is such that 0≤x≤(m−2)/2. The organic oxygen-comprising compounds of titanium can comprise several different organic radicals.

Mention may be made, among organic oxygen-comprising compounds, of alkoxides (such as Ti(O-n-C₄H₉)₄), phenoxides (such as Ti(OC₆H₅)₄), oxyalkoxides (such as TiO(OC₂H₅)₂), condensed alkoxides (such as Ti₂O(O-i-C₃H₇)₆), carboxylates (such as Ti(OOCCH₃)₄) and enolates (such as titanium acetylacetonate).

Use is preferably made, among all the compounds of titanium which are suitable, of those which only comprise titanium-oxygen-organic radical bonds per titanium atom, to the exclusion of any other bond. Alkoxides are highly suitable. The best results are obtained with titanium tetraalkoxides, in particular titanium tetrabutoxide.

The reaction of the at least one magnesium halide with at least one organic oxygen-comprising compound of titanium can be carried out by any appropriate known method, provided that it makes it possible to produce a complex in the liquid state. When the magnesium compound and/or the compound of titanium are liquid under the operating conditions of the reaction, it is desirable to carry out the reaction by simple mixing of these reactants in the absence of solvent or diluent. However, the reaction can be carried out in the presence of a diluent when the amount of liquid present in the reaction mixture is insufficient to bring the reaction to completion or when the two reactants are solid under the operating conditions of the reaction.

The amount of the compound of titanium employed in this step is usually defined with respect to the amount of the magnesium halide employed. It can vary within a wide range. It is generally at least 0.06 moles of titanium present in the titanium compound per mole of magnesium present in the magnesium halide, in particular at least 0.6 moles (per mole Mg), with values of at least 1.5 moles (per mole Mg) being the preferred values.

The amount is usually at most 4 moles of titanium present in the compound of titanium per mole of magnesium in the magnesium halide, more specifically at most 3 moles (per mole Mg), values of at most 2.5 moles (per mole Mg) being recommended.

The temperature at which the magnesium halide and the compound of titanium are brought together generally less than the decomposition temperature of the reactants and of the liquid complex obtained following the reaction. It is generally at least −20° C., in particular at least 0° C., temperatures of at least 20° C. being the most usual, temperatures of at least 100° C. being preferred. The temperature is usually at most 200° C., more especially at most 180° C., temperatures 140° C. to 160° C. being advantageous.

The duration of the reaction depends on the nature of the reactants and on the operating conditions and is advantageously sufficiently long to produce complete reaction between the reactants. The duration can generally vary from 10 minutes to 20 hours, more specifically from 1 to 15 hours, for example from 2 to 12 hours.

The pressure and the rate of addition of the reactants are not critical factors. For reasons of convenience, the reaction is generally carried out at atmospheric pressure; the rate of addition is generally chosen so as not to bring about sudden heating of the reaction mixture due to a possible self-acceleration of the reaction. The reaction mixture is generally stirred, so as to promote its homogenization, for the duration of the reaction.

The reaction can be carried out continuously or batch wise. The reaction is preferably performed between neat compounds of magnesium halide and the titanium compound i.e. in the absence of diluent.

The Mg-Ti liquid complex formed can be employed as is for the step of contacting the silica supported organomagnesium composition with the Mg-Ti liquid complex. It can optionally and preferably be diluted in a diluent, preferably an inert diluent before its subsequent use. The diluent is generally chosen from aliphatic or cycloaliphatic hydrocarbons preferably comprising up to 20 carbon atoms, such as, for example, alkanes, such as isobutane, pentane, hexane, heptane or cyclohexane or their mixtures. Hexane is particularly highly suitable. It is also generally preferred that any such diluent employed is the same as any diluent employed in the preparation of the silica supported organomagnesium composition. When diluted, the diluted Mg-Ti complex preferably comprises between 5 and 35 weight % of diluent; it is preferably characterised by a viscosity comprised between 4 and 120, more preferably between 5 and 20 mPa·s at 25° C.

The contacting of the silica supported organomagnesium composition with the Mg-Ti liquid complex can be carried out in any appropriate manner. It is usually carried out at a temperature from- 10° C., such as from 0° C., to a temperature of up to 150° C. The temperature of the impregnation is more preferably between 15° C. and 100° C. Reaction at the temperature used in step (1) is one preferred embodiment, whilst reaction at room temperature is also suitable. The Mg-Ti liquid complex may conveniently be added whilst the mixture of supported organomagnesium from the preceding step is cooling i.e. at a temperature between room temperature and the temperature of the preceding step.

The duration and the pressure at which the impregnation is carried out do not constitute critical parameters. The impregnation is generally carried out at atmospheric pressure; good results are obtained when the duration is this impregnation is comprised between 2 and 4 hours in order to ensure a satisfactory homogenisation.

Typically, the Mg-Ti complex is used in this step in an amount such that there is contacted with the silica supported organomagnesium composition between 0.1 and 2 mmoles of the Mg-Ti complex per gram of silica, such as between 0.1 and 1.5 mmoles of the Mg-Ti complex per gram of silica. This preferably corresponds to use of an amount of the complex which corresponds to at least 0.1 mmoles and at most 2 mmoles of magnesium per g of silica and at least 0.2 mmoles and at most 4 mmoles of titanium per g of silica, and more preferably to at least 0.1 mmoles and at most 1.5 mmoles of magnesium per g of silica and at least 0.2 mmoles and at most 3 mmoles of titanium per g of silica.

Typically the amount of Mg-Ti liquid complex used is such that the amount of magnesium contacted with the silica supported organomagnesium composition in this step is between 5 and 30% relative to the amount of magnesium/dialkylmagnesium compound contacted with the silica support in the earlier step.

There is obtained from this contacting a modified supported organomagnesium composition.

The amount of Mg-Ti liquid complex used is preferably chosen so that the modified supported organomagnesium composition comprises
at least 0.1 mmoles and at most 2 mmoles of magnesium per g of silica support which is derived from the Mg-Ti liquid complex (i.e. not including the magnesium already present), and
at least 0.2 mmoles and at most 4 mmoles of titanium per g of silica support.

Typically the amount of magnesium in the modified supported organomagnesium composition after this step and which derives from the Mg-Ti liquid complex addition is between 5 and 30% relative to the amount of magnesium in the catalyst after this step which derives from the dialkylmagnesium addition.

In step (3) of the process of the present invention the modified supported organomagnesium composition from step (2) is reacted with a titanium halide.

In one embodiment the modified supported organomagnesium composition from step (2) may be separated by evaporation of any solvent present. Preferably, however, step (3) takes place by adding titanium halide, optionally diluted in diluent or solvent such as hexane, to a mixture of the modified supported organomagnesium composition also in a diluent or solvent, again such as hexane. In this case, therefore, the mixture obtained after addition of Mg-Ti liquid complex to the supported organomagnesium in step (2) may be used “as is”, and the titanium halide (solution) added.

Any suitable titanium halide may be used, although titanium chlorides are preferred, and most preferably the titanium halide is titanium tetrachloride. The titanium halide may be added in a single or multiple additions during the duration of this step.

This step may conveniently be carried out at room temperature, although temperatures below room temperature, such as from 0° C., or above room temperature, such as up to 100° C. are not precluded. The duration and the pressure are again not critical parameters. The reaction is generally carried out at atmospheric pressure; good results are obtained when the duration is this impregnation is comprised between 6 and 24 hours. The mixture may be stirred or otherwise mixed continually or occasionally during this period.

Typically the amount of titanium used in this step is such that the amount of titanium in the Mg-Ti liquid complex contacted with the silica supported organomagnesium composition in the earlier step is between 5 and 30% relative to the amount of titanium which is added in the titanium halide addition of this step.

(Or put another way, typically the amount of titanium added as titanium halide in this step is between 3.3 time and 20 times the amount of titanium in the Mg-Ti liquid complex contacted with the silica supported organomagnesium composition in the earlier step.)

Typically, the amount of titanium halide used in this step is comprised between 2 to 15 moles, preferably between 3 and 12 moles, and more preferably between 4 to 9 moles, per mole of the Mg-Ti complex contacted with the silica supported organomagnesium composition in step (2) of the process.

Typically, the amount of titanium halide used in this step is comprised between 1 to 10 mmoles per gram of silica, more preferably between 2 to 7 mmoles per gram of silica.

At the end of the reaction excess liquid is decanted off, and the obtained solid dried, for example by application of vacuum.

Preferably, the amount of magnesium in the obtained catalyst composition which derives from the Mg-Ti liquid complex addition is between 5 and 30% relative to the amount of magnesium which derives from the dialkylmagnesium addition. (This being the same as the ratio in the modified supported organomagnesium composition as already described.)

Preferably, the amount of titanium in the obtained catalyst composition which derives from the Mg-Ti liquid complex addition is between 5 and 30% relative to the amount of titanium which derives from the titanium halide addition.

Preferably there is obtained, after addition of the titanium halide a composition which comprises:
silica,
from 0.5 to 5 mmoles per gram of silica of magnesium derived from a dialkylmagnesium compound of the formula RMgR1, where R and R1 are the same or different C2-C12 alkyl groups, from 0.1 mmoles to 1 mmole per gram of silica of magnesium from 0.2 mmoles to 2 mmoles per gram of silica support of titanium, derived from a Mg-Ti liquid complex added to the support, and
from 1 to 10 mmoles per gram of silica of titanium derived from a titanium halide.

The process of the present invention may further comprise adding one or more compounds which may act as an internal electron donor. Typically, when added, such compounds are added after step (3). Any suitable internal electron donor compound as known in the art may be used. Known and typical electron donors are oxygenated hydrocarbon compounds, such as ethers, esters, alcohols, ketones and the like. The electron donors may be aliphatic, aromatic, cyclic or linear oxygenated hydrocarbons.

Preferred internal electron donors in the present invention are ethers, with particular preference for the use of an internal electron donor selected from tetrahydrofuran (THF), isoamylether (IAE) and bis-(4-chlorobutyl)ether (CBE).

In a second aspect, the present invention also provides a catalyst composition which is useful in olefin polymerisation, said composition comprising:
silica,
from 0.5 to 5 mmoles per gram of silica of magnesium derived from a dialkylmagnesium compound of the formula RMgR1, where R and R1 are the same or different C2-C12 alkyl groups, from 0.1 mmoles to 1 mmole per gram of silica of magnesium from 0.2 mmoles to 2 mmoles per gram of silica support of titanium, derived from a Mg-Ti liquid complex added to the support, and
from 1 to 10 mmoles per gram of silica of titanium derived from a titanium halide.

In a third aspect, which is also a preferred embodiment of the second aspect, the present invention also provides a catalyst composition which is useful in olefin polymerisation, said composition being obtained by the process of the first aspect of the invention.

The SiO₂ content of the catalyst composition is generally not more than 70 weight %; it is preferably more than 40 weight %, more preferably more than 50 weight %.

The total titanium content of the catalyst composition is comprised between 1 and 12 weight %, preferably between 1 and 8 weight %, and most preferably between 3 and 7 weight %. Preferably from 50 to 95% of the total amount of titanium, such as from 70 to 90%, is titanium derived from the titanium halide.

The magnesium content of the catalyst composition is comprised between 0.5 and 6 weight %, preferably between 2 and 5 weight %. Preferably from 50 to 95% of the total amount of magnesium, such as from 70 to 90%, is magnesium derived from the dialkylmagnesium.

The molar ratio between the titanium and the magnesium of the catalyst composition is preferably comprised between 0.3 and 3, more preferably comprised between 0.5 and 2.5, most preferably comprised between 0.75 and 2.0.

The catalyst composition generally comprises halogen, typically chlorine. The halogen content of the catalyst composition is preferably comprised between 5 and 30 weight %, preferably between 10 and 25 weight %.

The catalysts according to the invention are particularly suited to the polymerisation of olefins. The invention also relates to the use of these catalysts, in combination with a cocatalyst chosen from organometallic compounds of a metal from Groups 1, 2, 12, 13, and 14, in the polymerisation of olefins. The organometallic compound which serves as activator of the catalyst and which is commonly known as “co-catalyst” can be chosen from organometallic compounds of lithium, magnesium, zinc, aluminium or tin. The best results are obtained with organoaluminium compounds.

Use may be made, as organometallic compound, of totally alkylated compounds with straight or branched alkyl chains comprising up to 20 carbon atoms, such as, for example, n-butyllithium, diethylmagnesium, diethylzinc, tetraethyltin, tetrabutyltin and trialkylaluminiums. Use may also be made of alkylmetal hydrides in which the alkyl radicals also comprise up to 20 carbon atoms, such as diisobutylaluminium hydride and trimethyltin hydride. Alkylmetal halides in which the alkyl radicals also comprise up to 20 carbon atoms, such as ethylaluminiumsesquichloride, diethylaluminium chloride and diisobutylaluminium chloride, are also suitable. Use may also be made of organoaluminium compounds obtained by reacting trialkylaluminiums or dialkylaluminium hydrides, the radicals of which comprise up to 20 carbon atoms, with diolefins comprising from 4 to 20 carbon atoms and more particularly the compounds known as isoprenylaluminiums.

Preference is generally given to trialkylaluminiums and in particular to those with straight alkyl chains comprising up to 18 carbon atoms, more particularly from 2 to 8 carbon atoms. Triethylaluminium and triisobutylaluminium are preferred.

The catalyst may be activated in situ by adding the cocatalyst and the prepared supported catalyst composition separately to the polymerisation medium. It is also possible to combine the catalyst composition and cocatalyst before introduction into the polymerisation medium, e.g., for up to about 2 hours at a temperature from about −40° C. to about 80° C.

A suitable activating amount of the cocatalyst may be used. The number of moles of cocatalyst per gram atom of titanium in the catalyst may be, e.g., from about 1 to about 100 and is preferably greater than about 5.

In embodiments there may also be added an “activity booster” which, as the name suggests, can provide an increased activity. Suitable activity boosters include halogenated compounds such as chlorinated or brominated compounds. One class of preferred activity boosters is halogenated hydrocarbons where the hydrocarbon is an alkyl group containing from 1 to 10, preferably from 1 to 7 carbon atoms, or an aralkyl or aryl group containing from 6 to 14, preferably from 6 to 10 carbon atoms. Another class of preferred activity boosters is alkylaluminium halides, particularly where the alkyl group contains from 1 to 7 carbon atoms. The most preferred activity boosters are chlorine containing compounds. Examples include chloroform, methylene chloride, ethyl chloride, propyl chloride, butyl chloride, pentyl chloride, hexyl chloride, heptyl chloride, diethylaluminium chloride (DEAC) and cyclohexyl chloride (CyCl).

The catalyst as described above can be used in any suitable polymerisation process. In embodiments, it may be used in a slurry phase process A slurry process typically uses an inert hydrocarbon diluent and temperatures from about 0° C. up to a temperature just below the temperature at which the resulting polymer becomes substantially soluble in the inert polymerisation medium. Suitable diluents include toluene or alkanes such as hexane, propane or isobutane. Preferred temperatures are from about 30° C. up to about 200° C. but preferably from about 50° C. to 125° C. Loop reactors are widely used in slurry polymerisation processes. In a loop reactor the slurry is typically circulated in the reactor by means of a pump or agitator. Liquid full loop reactors are particularly well known in the art and are described for example in U.S.

U.S. Pat. Nos. 3,152,872, 3,242,150 and 4,613,484. Additional references of slurry operations wherein the present invention can advantageously be used are WO2007138257 and WO2006056763. Loop slurry polymerisation is typically carried out at temperatures in the range 50-125° C. and at pressures in the range 1-100 bara. The product slurry, comprising polymer and diluent and in most cases also catalyst, olefin monomer and comonomer can be discharged intermittently or continuously.

The present invention is particularly useful in a continuous gas phase process for the polymerisation. The process may be operated, for example, at a pressure from 10 to 500 psi, with a reaction mixture comprising from 0 to 60 mole % hydrogen, from 0 to 35 mole % of one or more C₃₋₈ alpha-olefins, from 15 to 100 mole % of ethylene and from 0 to 75 mole % of an inert gas such as N₂, conducted at a temperature from 50° C. to 125° C., preferably less than 115° C. in the presence of a catalyst and a co-catalyst as described above.

The gas phase and particularly the fluidized bed gas phase polymerisation of ethylene polymers has been known for some time. A broad general description of these types of processes is set out in the paper “Gas Phase Ethylene Polymerization: Production Processes, Polymer Properties, and Reactor Modelling”, by Tuyu Xie, Kim B. McAuley, James C. C. Hsu, and David W. Bacon, Ind. Eng. Chem. Res. 1994, 33, 449-479.

Generally, a monomer feed comprising at least ethylene and optionally one or more C₃₋₈ alpha-olefins is fed to a gas phase fluidized bed or stirred bed reactor. The monomer mixture optionally together with hydrogen and/or an inert gas are fed to the fluidized bed. In a fluidized bed reactor, the velocity of the gas is sufficient to suspend the bed in the fluid flow of monomer and other components. In a stirred bed reactor mechanical agitation serves to help suspend the bed. Generally a fluid bed reactor is vertical and a stirred bed reactor is horizontal. Concurrently with the monomers a co-catalyst and a supported catalyst are fed to the bed. The monomer passing over the catalyst polymerises on the catalyst and in the pores of the catalyst causing the particle to increase in size and to break. The resulting polymer particle continues to grow as it resides in the reactor. In a stirred tank reactor the bed is stirred to a discharge section and leaves the reactor. In a fluidized bed the reactor typically has a narrower section to keep the fluid (gas) velocity sufficiently high to fluidize the bed. There is an expanded zone at the top of the reactor to reduce the speed of the gas passing through the reactor so the polymer/catalyst particles fall back into the bed. The discharge is from the bed zone in the reactor.

In both the fluidized bed and stirred bed the polymer particles removed from the reactor are degassed to remove any volatile material and the resulting polymer (with entrained catalyst) may then be further treated (e.g. stabilizers added and pelletized if necessary).

In the reactor the gas phase typically comprises the monomers, a balance gas such as nitrogen, a molecular weight control agent such as hydrogen, and depending on the process possibly a condensable liquid (i.e. condensing mode such as disclosed in U.S. Pat. No. 4,543,399 issued Sep. 24, 1985 to Jenkins III et al. ; U.S. Pat. No. 4,588,790 issued May 15, 1986 to Jenkins III et al. ; and the so-called super condensing mode as disclosed in U.S. Pat. No. 5,352,749 issued Oct. 4, 1994 to DeChellis et al., assigned to Exxon Chemical Patents, Inc. and U.S. Pat. No. 5,436,304 issued Jul. 25, 1995 to Griffin et al., assigned to Exxon Chemical Patents, Inc.). Additional references of gas phase operations wherein the present invention can advantageously be used are WO9428032, WO2010037650 and international patent application number PCT/EP2011/070280.

The condensable liquid can be a condensable monomer, e.g. but-1-ene, hex-1-ene, 4-methylpent-1-ene, cyclo-octene, 1-pentene or octene used as a comonomer, and/or an optional inert condensable liquid, e.g. inert hydrocarbon(s), such as C4-C8 alkane(s) or cycloalkane(s), particularly butane, pentane or hexane. The partial pressure of said condensable liquid under reaction conditions is preferably greater than 2 bars.

The present invention is advantageously used at very high Space Time Yields.

The Space Time Yield (“STY”) is expressed in [kg/(m³×h)] is well known and represents the weight of polymer produced per unit of time and per unit of reactor volume. STY equal or higher than 100 kg/(m³×h) and even 120 kg/(m³×h) are preferred.

The reactor mixture comprises from 0 to 60 mole % hydrogen, from 0 to 35 mole % of one or more C₃₋₈ alpha-olefins, from 15 to 100 mole % of ethylene and from 0 to 75 mole % of an inert gas such as N₂. Copolymerisable olefins include butene (1-butene), 4-methyl-1-pentene, pentene, hexene (1-hexene) and octene (1-octene), although it may be difficult to keep significant amounts of octene in the gas phase. The polymer may have a density from 0.905 to 0.965 g/cc, typically from about 0.910 to about 0.960 g/cc.

Fluidized bed gas phase reactors to make polyethylene are generally operated at temperatures from about 50° C. up to about 125° C. (provided the sticking temperature of the polymer is not exceeded) preferably from about 75° C. to about 110° C. and at pressures typically not exceeding 3,447 kPa (about 500 psi) preferably not greater than about 2,414 kPa (about 350 psi).

Polymerisation additives can also advantageously be added during the polymerisation process according to the present invention. Activity booster additives are preferred. For example, halogenated hydrocarbon compound can be advantageously introduced during the polymerisation in amounts effective for increasing the catalyst activity, the amount being preferably such that the molar of the quantity of the halogenated hydrocarbon compound to that of catalyst titanium introduced into the polymerisation medium is greater than 0.001 and lower than 10. Said amount of halogenated hydrocarbon compound can also be advantageously controlled such that the molar ratio of the halogenated hydrocarbon compound to the cocatalyst is comprised between 0.03 and 0.2. The halogenated hydrocarbon compound can be a mono or a polyhalogenated saturated hydrocarbon and is preferably selected amongst the group consisting of methylene chloride, chloroform, carbon tetrachloride, trichloro-1,1,1 ethane and dichloro-1,2 ethane; monoalkyl chloride (R-Cl) like e.g. butyl chloride are preferably used. Examples thereof can be found in EP0703246, WO0228919 and EP1350802.

Typically the resulting polymer will comprise from 85 to 100 weight % of ethylene and from 0 to 15 weight % of one or more C₃₋₈ alpha-olefins. The polymer should have a molecular weight (weight average, Mw) greater than 50,000 Da.

The resulting polymers may be used in a number of applications such as film extrusion, both cast and blown film extrusion and both injection and rotomolding applications. Typically the polymer may be compounded with the usual additives including heat and light stabilizers such as hindered phenols; ultraviolet light stabilizers such as hindered amine light stabilizers (HALS); process aids such as fatty acids or their derivatives and fluoropolymers optionally in conjunction with low molecular weight esters of polyethylene glycol.

The present invention will now be illustrated by the following nonlimiting examples.

### EXAMPLES

### Example 1

### Preparation of Mg-Ti Complex

(n-BuO)₄Ti and MgCl2 were both obtained from Merck. The (n-BuO)₄Ti was dried by distillation at 250° C. whilst the MgCl₂ was dried by heating to 250° C. at reduced pressure. A mixture of the (n-BuO)₄Ti (117.5 mmol) and anhydrous MgCl₂ (58.5 mmol) was stirred at 155° C. for 12 hours. The reaction mixture was left to cool down to room temperature and the product (a viscous oil) was decanted from the small amount of remaining MgCl₂. This product, {[(n-BuO)₄Ti]₂ MgCl₂}₂ was used for synthesis below without further purification.

### Preparation of Silica Support

ES757 silica, obtained from Ecovyst was heated at a temperature of 200° C. for 5 hours under nitrogen. The resulting silica support had a surface hydroxyl content, determined according to the method described in WO 99/05187 of 1.5 mmole/g of silica.

### Preparation of Catalyst

2 g of the dried ES757 silica was placed in a Schlenk tube and, under a flow of nitrogen and with shaking at 1500 rpm using a MX-S Vortex mixer, was reacted with 6.1 mmol of n-butyl-s-butyl-magnesium (corresponding to 3.05 mmol/g of silica) in hexane to form a silica supported organomagnesium composition. The reaction was exothermic. The mixture was allowed to react over 30 minutes with regular shaking and heating to 50° C., evaporating the heptane.

Subsequently, 6.25 mmol of tetraethyl orthosilicate (tetraethoxysilane) in 15 ml of dry heptane was added, again with shaking, and the mixture heated to 50° C. for 1 hour. The liquid was decanted and the solids washed with dry heptane.

1.25 g of the Mg-Ti complex prepared above was dissolved in dry heptane and added to the solids (corresponding to 1.61 mmol Ti/g support and 0.81 mmol Mg/g of the initial silica). The mixture was allowed to react with regular shaking over 30 minutes before the solvent was removed at reduced pressure.

The obtained solids were slurried in heptane and 10 mmol of TiCl₄ (corresponding to 5 mmol/g of the initial silica) in heptane was added at room temperature with regular shaking for 30 minutes before the mixture was then left to stand for 12 hours. The liquid was decanted and the solids washed several times with dry heptane, before being dried by heating at 50° C.

The obtained catalyst comprised 7.1 wt % titanium and 3.8wt % magnesium.

### Polymerisation

Polymerisation was performed is a Fischer-Porter glass reactor using 10 mg of the above-prepared catalyst in 250 ml of heptane as diluent at a temperature of 75°. The reactant gas mixture comprised 3.85 bar of ethylene and 0.15 bar of hydrogen. 1 mmol of triethyl aluminium was added as a co-catalyst. Polymerisation was performed for 50 minutes.

28.5g of polyethylene was obtained, corresponding to a catalyst activity of 3450 g/g cat/h.

### Example 2

The silica and catalyst preparation steps were similar to that of Example 1 except that dichlorodiethoxysilane was used in place of tetraethyl orthosilicate during the preparation, and the additions were changed such that only 0.93 g of the Mg-Ti complex and 3.8 mmol of TiCl₄ were added. The obtained catalyst comprised 3.9wt % titanium and 4.7wt % magnesium.

Polymerisation was performed in the same manner as Example 1 except that 12 mg of catalyst was used and polymerisation was performed for 60 minutes. 39.5 g of polyethylene was obtained, corresponding to a catalyst activity of 3292 g/g cat/h.

### Example 3

The same catalyst was used as in Example 2, and polymerisation was performed in the same manner as Example 2 except that 14 mg of catalyst was used and 100 mg of cyclohexyl chloride was also added to the reactor. 71.6 g of polyethylene was obtained, corresponding to a catalyst activity of 5114 g/g cat/h.

### Example 4

The silica and catalyst preparation steps were similar to that of Example 1 except that the silica used was ES70W and that 5 mmol of TiCl₄ were added rather than 10 mmol. As in Example 1 the silica was heated at a temperature of 200° C. for 5 hours under nitrogen. The resulting silica had a surface hydroxyl content, determined according to the method described in WO 99/05187 of 1.6 mmole/g of silica.

The obtained catalyst comprised 6.1wt % titanium and 4.1 wt % magnesium.

Polymerisation was performed in the same manner as Example 1 except that 14 mg of catalyst was used and reaction was performed for 60 minutes. 55.1 g of polyethylene was obtained, corresponding to a catalyst activity of 3957 g/g cat/h.

### Comparative Example 1

A catalyst was prepared according to the teaching of WO9905187 using ES70W silica (i.e. the catalyst preparation includes addition of a dialkyl magnesium, tetraethyl orthosilicate and titanium tetrachloride, but not a Mg-Ti complex). The obtained catalyst comprised 3.4wt % titanium and 1.7wt % magnesium.

Polymerisation was performed in the same manner as Example 1 except that 11 mg of catalyst was used, 100 mg of cyclohexyl chloride was also added to the reactor, and reaction was performed for 60 minutes. 15.4 g of polyethylene was obtained, corresponding to a catalyst activity of 1400 g/g cat/h.

1. A process for preparing an alpha-olefin polymerisation catalyst composition, the process comprising
(1) reacting a silica support with a dialkylmagnesium compound having a formula RMgR1, where R and R1 are the same or different C₂-C₁₂ alkyl groups, in order to form a silica supported organomagnesium composition,
(2) reacting at least one magnesium halide with at least one organic oxygen-comprising compound of titanium to form a Mg-Ti liquid complex, and contacting the silica supported organomagnesium composition of step (1) with the formed Mg-Ti liquid complex to form a modified supported organomagnesium composition, and
(3) reacting the modified supported organomagnesium composition of step (2) with a titanium halide.

2. The process of claim 1, wherein the silica is spherical and/or spheroidal with a median particle size of from 5 to 200 μm and a surface area of from 100 m²/g to 500 m²/g.

3. The process of claim 1 wherein the silica support has a residual surface hydroxyl content comprising between 0.6 and 2 mmole/g of silica prior to the reaction with the dialkylmagnesium.

4. The process of claim 1 wherein the dialkylmagnesium is selected from butylethylmagnesium, butyloctylmagnesium and dibutylmagnesium, with dibutylmagnesium being a most preferred dialkylmagnesium.

5. The process of claim 1 wherein an amount of dialkylmagnesium added to the silica support is between 0.5 to 5 mmoles per gram of silica.

6. The process of claim 1 wherein the silica supported organomagnesium composition is reacted with a silicon containing compound of formula Si(OR)_{y}(X)_{z}, where X is a halogen, R is C2-C6 alkyl, and y+z=4 prior to step (2).

7. The process of claim 6 wherein the silicon containing compound is added in an amount between 0.2 to 0.8 mmoles per gram of silica and/or in an amount to provide a molar ratio of silicon containing compound to magnesium in the silica supported organomagnesium composition of about 0.2 to about 1.6.

8. The process of claim 1 wherein the Mg-Ti liquid complex is prepared by reacting magnesium chloride with the at least one organic oxygen-comprising compound of titanium.

9. The process of claim 1 wherein the organic oxygen-comprising compound of titanium comprises a tetravalent titanium selected from alkoxides, phenoxides, oxyalkoxides, condensed alkoxides, carboxylates and enolates.

10. The process of claim 1 wherein an amount of the organic oxygen-comprising compound of titanium corresponds to at least 0.6 moles and at most 4 moles of titanium per mole of magnesium in the magnesium halide.

11. The process of claim 1 wherein an amount of Mg-Ti liquid complex used in step (2) is such that the silica supported organomagnesium composition is contacted in step (2) with
at least 0.1 mmoles and at most 2 mmole of magnesium per g of silica support, and
at least 0.2 mmoles and at most 4 mmoles of titanium per g of silica support.

12. The process of claim 1 wherein the titanium halide used in step (3) is titanium tetrachloride.

13. The process of claim 1 wherein the an amount of Mg-Ti liquid complex used in step (2) is such that an amount of magnesium contacted with the silica supported organomagnesium composition in step (2) is between 5 and 30% relative to an amount of magnesium contacted with the silica support in the dialkylmagnesium addition of step (1).

14. The process of claim 1 wherein an amount of titanium halide in step (3) is such that an amount of titanium used as is between 3.3 time and 20 times an amount of titanium in the Mg-Ti liquid complex contacted with the silica supported organomagnesium composition in step (2).

15. A catalyst composition which is useful in olefin polymerisation, said composition comprising:
silica,
from 0.5 to 5 mmoles per gram of silica of magnesium derived from a dialkylmagnesium compound having a formula RMgR1, where R and R1 are the same or different C2-C12 alkyl groups,
from 0.1 mmoles to 1 mmole per gram of silica of magnesium from 0.2 mmoles to 2 mmoles per gram of silica support of titanium, derived from a Mg-Ti liquid complex added to the support, and
from 1 to 10 mmoles per gram of silica of titanium derived from a titanium halide.

16. A catalyst composition which is useful in olefin polymerisation, said composition being obtained by the process of claim 1.

17. A process for polymerisation of an olefin, which process comprises polymerising the olefin in the presence of a catalyst composition according to claim 16.

18. The process of claim 1 wherein the organic oxygen-comprising compound of titanium is a titanium tetraalkoxide.
